(19) United States
(12) Patent Application Publication
(10) Pub. No.: US 2026/0266110 A1
(43) Pub. Date: Sep. 10, 2026

(54) LOCKING BAR ARRANGEMENT

(71) Applicant: EMKA BESCHLAGTEILE GMBH & CO. KG, Velbert (DE)

(72) Inventor: Gerd RIEBOLDT, Wuppertal (DE)

(21) Appl. No.: 18/869,496

(22) PCT Filed: May 10, 2023
(86) PCT No.: PCT/DE2023/100339

§ 371 Date: Nov. 26, 2024

(30) Foreign Application Priority Data
May 30, 2022 (DE) 10 2022 113 577.2

(51) Int. Cl. E05C 9/20

(52) U.S. Cl. CPC E05C 9/20

(57) ABSTRACT

A rod lock for locking a door with a first rod and a second rod firmly connected to the first rod via a rod adapter, in which the rod adapter has a first fastening area and a second fastening area. The first rod is connected to the rod adapter in an upright manner in the first fastening area and the second rod is connected to the rod adapter in a lying manner in the second fastening area.

This application is a national stage filing of International (PCT) Application No. PCT/DE2023/100339, corresponding to International Publication No. WO 2023/232182 filed on May 10, 2023, which in turn claims priority to German Application No. 10 2022 113 577.2 filed on May 30, 2022. The entire contents of both of those applications are hereby incorporated by reference.

The disclosure relates to a rod lock for locking a door with a first rod and a second rod firmly connected to the first rod via a rod adapter.

### BACKGROUND

Rod locks of this type are used in a wide variety of technical applications to lock a door leaf to a door frame, for example in industrial systems, switch cabinets, server cabinets or similar applications. For this purpose, an operating element located on the outside of the door is usually actuated, which sets one or more rods of the rod lock in motion and either locks or unlocks the door.

The operating element is usually operatively connected to a lock case arranged on the inside of the door. One or two rods of the rod lock are movably accommodated in the lock case. These rods held in the lock case are usually relatively short and, depending on the application, i.e. in particular depending on the size of the door, etc., are extended with a second rod according to the respective requirement.

The rods can be connected either directly, for example by screwing, riveting or similar, or via a rod adapter that connects the rods to each other. Since the rods in the lock case usually interact with one or more gears, the rods of known rod locks are usually designed as flat rods and arranged in an upright manner. In this context, the term “upright” refers to an arrangement of the rod in which its long cross-sectional side extends perpendicular to the plane of the door.

However, applications are also known in which rods arranged in a lying manner are used, for example due to limited installation space, with the long cross-sectional side extending parallel to the door plane. These horizontally arranged rods cannot be easily connected to the rods that are conventionally arranged vertically in the lock case. For this reason, special lock cases often have to be developed for horizontal rods, which involves a certain amount of effort.

### SUMMARY

Against this background, the present disclosure can specify a rod lock in which rods arranged in a lying manner can also be connected in a simple manner to a conventional lock case with rods arranged in an upright manner.

This can be achieved in a rod lock of the type mentioned at the beginning in that the rod adapter has a first fastening area and a second fastening area, the first rod being connected to the rod adapter in an upright manner in the first fastening area and the second rod being connected to the rod adapter in a lying manner in the second fastening area.

In this way, the rod adapter not only allows a fixed connection of the first rod to the second rod, but also a reorientation from an upright to a lying rod. By using this adapter, horizontal rods can therefore also be connected to conventional lock cases without major effort.

An embodiment provides for the first rod and the second rod to be arranged so as to be axially movable via an operating element. By actuating the operating element, the first rod can be moved together with the second rod. The operating element can be a folding handle, a swivel handle, a lever handle, a key plate with actuator or a similar operating element.

In a further embodiment, the first rod is movably accommodated in a lock case that is operatively connected to the operating element. The first rod can be moved back and forth axially via the lock case, thereby locking or opening the rod lock. Two rods can also be accommodated in the lock case in opposite directions, thus forming a double-action rod lock.

An easy-to-install design provides for the first fastening area and the first rod to be connected to each other via a latching connection. The first rod can be fixed to the rod adapter without tools via the latching connection.

A further embodiment provides for the first fastening area to have a fastening tab with a fastening opening. The fastening tab can be used to connect the rod adapter to the first rod. The fastening tab can have a flat geometry and be arranged vertically, i.e. the main surface of the tab is perpendicular to the door plane.

In this context, it may be advantageous if the first rod has a rod connector at its free end, into which the fastening tab is inserted. A lateral offset of the rod direction of the first rod can be achieved via the rod connector. The lateral offset can be used, for example, in the case of two-rod locks, to ensure that these are parallel and spaced apart in the lock case, but then run coaxially above and below the lock case via the offset.

A further embodiment provides for the rod connector to be integrally connected to the rod. For example, the first rod can be designed as a plastic rod and the rod connector can be integrally molded onto the rod. This results in a small number of parts combined with low manufacturing and assembly costs.

An embodiment provides for the fastening tab to be inserted upright into the rod connector and latched to it via the fastening opening. A latching element, such as a latching lug, latching tongue or similar element, spring-mounted on the rod connector can latch into the fastening opening and lock the fastening tab on the rod connector. Due to the upright insertion direction of the fastening tab, rods can also be inserted into the rod connector in an upright orientation instead of the rod adapter, should this be required. This increases the range of applications for the lock case fitted with the first rod.

Furthermore, it is proposed that the second fastening area and the second rod are connected to each other via a latching connection. In this respect, too, it is not necessary to use additional tools to connect the second rod to the rod adapter. Instead, the second rod can be connected to the second fastening area without tools in just a few simple steps.

In this context, it is further proposed that the second rod has a latching receptacle for receiving a latching element arranged on the second fastening area. The latching receptacle can be molded directly onto the rod or connected to it as a separate attachable shoe. The rod can be latched onto the element arranged on the second fastening area of the rod adapter in the manner of a latching connection via the latching element with its latching receptacle.

In this context, a design in which the latching element is designed as a latching bolt and the latching receptacle encloses the latching bolt in the latched position by an angle of more than 180°, in particular more than 200°, may be advantageous. The second rod and the latching receptacle can be made of plastic. The latching receptacle can expand when it is pushed onto the latching bolt and then spring back due to its inherent elasticity and enclose the bolt by more than 180°, in particular more than 200°. This results in a kind of clipping.

A further embodiment provides for the second fastening area to have a mounting opening. The mounting opening can be used to mount the second rod.

A design in which the latching element and the latching receptacle are arranged at least partially in the mounting opening may be advantageous in terms of design.

For reliable mounting of the second rod on the rod adapter, it may be advantageous if the width of the mounting opening on the side of the rod facing the first fastening area is smaller than the width of the mounting opening on the side of the rod facing away from the first fastening area.

In this context, it is further proposed that the latching element is arranged in the area of the mounting opening with the narrow width.

In this context, it may be advantageous if the width of the rod at its free end is smaller than its remaining width. The free end of the rod can be latched to the adapter element. It has been found that a latching connection is not necessary over the entire width of the rod, but that a latching connection over a slightly smaller width is sufficient to transmit the required rod forces.

In this context, it may be advantageous if the latching receptacle is also arranged at the free end of the rod.

A further embodiment is that the width of the second rod corresponds to the width of the mounting opening in such a way that the rod fits precisely in the mounting opening. Due to the precise fit of the second rod in the mounting opening, transverse forces acting transverse to the axis of the rod can also be introduced into the rod via the adapter.

Another potential advantage in this context is a design in which one of the top sides of the rod rests against a support surface of the mounting opening.

A further embodiment provides for the second rod to be connected to a attachable shoe. The connection to the attachable shoe can be made at the end of the second rod facing away from the rod adapter.

The attachable shoe can have an attachment area for connection to the second rod. In this way, the attachable shoe can be connected to the second rod without tools, even by an inexperienced fitter.

A design in which the attachment area is connected to the rod via a large number of barbs may be advantageous in this context. The barbs ensure that the attachable shoe reliably hooks onto the rod. Due to the large number of barbs, even if one or more barbs fail, there is reduced or no risk of the attachment area coming loose unintentionally. The result is both simple and reliable installation of the attachable shoe on the rod.

A potential advantage in this context is a design in which the attachment area is connected to the second rod without tools and/or non-detachably. Tool-free assembly keeps the assembly effort to a minimum and also prevents assembly errors. Due to the non-detachable connection, it is not possible to remove the attachable shoe from the rod afterwards in a non-destructive manner.

An embodiment provides that the attachment area for receiving the second rod has an attachment opening in which the barbs are arranged. The attachment opening can extend in the longitudinal direction of the second rod. The size of the attachment opening can be adapted to the cross-section of the rod. The second rod can be designed as a flat rod and the attachment opening can have a correspondingly rectangular cross-sectional area.

The attachment opening can have a row of barbs on each of two opposite sides extending parallel to the insertion direction of the second rod. In this way, the rod is held symmetrically in the attachment opening by the barbs engaging on both sides.

A further embodiment provides for the barbs to extend in an angled and/or curved manner in the direction of insertion of the second rod. This prevents the second rod from being pulled out of the attachment area. Due to their angled and/or curved shape in the direction of insertion, the barbs counteract any pulling out. The second rod can only be moved in one direction relative to the barbs.

A further embodiment provides for the attachment area to have a side opening extending transversely to the insertion direction of the second rod. The side opening can have manufacturing advantages if the attachable shoe is manufactured as a plastic part in an injection molding process. In this case, part of the tool can enter the area of the barbs via the side opening. In addition, a visual inspection can be carried out via the side opening to check whether the second rod has been inserted sufficiently deep into the attachment opening.

A further embodiment is that the attachable shoe has a locking area for locking the rod to the lock holder. The door leaf can therefore be locked to the door frame via the attachable shoe.

In this context, it may be advantageous if the locking area is aligned parallel to the second rod.

Another design advantage may be a configuration in which the locking area is axially offset from the second rod. In this way, the locking level of the rod lock can be laterally offset to the rod level.

Advantageously, the locking area has a locking element. The locking element can be a locking pin, a locking lug or a similar element. The locking element can have a locking bevel on its locking side that runs at an angle to the locking direction.

Another advantage is a design according to which the width of the second rod in a plug on area that can be inserted into the attachment area of the attachable shoe is smaller than the remaining width of the rod. This results in a streamlined design of the end area of the rod in which the attachable shoe is attached.

Finally, an embodiment according to which the second rod and/or the attachable shoe are made of plastic may be advantageous in terms of production technology. In particular, the attachable shoe can be manufactured using an injection molding process. The second rod can also be designed as a continuous cast profile. In addition to potential production-related advantages, there may also be cost advantages.

Finally, it is proposed that the attachable shoe is designed as a plastic injection-molded part and that the barbs are formed in one piece or as a separate part on the attachable shoe. If the barbs are arranged in one piece on the attachable shoe, this results in a simple design. If the barbs are designed as a separate part on the attachable shoe, it is possible to manufacture the barbs from a different material than the attachable shoe. In this case, the barbs can be inserted using a multi-component injection molding process. It is also possible to overmold the barbs.

### BRIEF DESCRIPTION OF THE DRAWINGS

Further details of a bar closure according to the disclosure will be explained below with the aid of the attached drawings of an embodiment example.

FIG. 1 is a perspective view of a closed door with a rod lock in its locked position;

FIG. 2 is a view corresponding to the illustration in FIG. 1 with the rod lock in its unlocked position;

FIG. 3 a) is a perspective view of the rod lock, showing the locked position of the rod lock;

FIG. 3 b) is a perspective view showing the unlocked position of the rod lock;

FIG. 4 a) is a view of the rod lock, where a cover of the lock case is not shown to illustrate the inside of the lock case;

FIG. 4 b) is a top view of the rod lock;

FIG. 4 c) is a sectional view of the rod lock;

FIG. 5 is a perspective view of the rod adapter;

FIG. 6 is a perspective view of the rod adapter from FIG. 4 viewed from a different direction;

FIG. 7 is an enlarged view of the rod adapter according to the detail labeled VII in FIG. 3;

FIG. 8 is an enlarged view according to the detail labeled VIII in FIG. 4 c);

FIG. 9 is an enlarged view according to the detail labeled IX in FIG. 4 a);

FIG. 10 is a perspective view of a attachable shoe;

FIG. 11 is another perspective view of the attachable shoe as shown in FIG. 10, viewed from a different direction;

FIG. 12 is an enlarged detailed view according to the detail labeled XII in FIG. 4 b);

FIG. 13 is an enlarged detailed view according to the detail labeled XIII in FIG. 4 c); and

FIG. 14 is a perspective view of a lock holder.

### DETAILED DESCRIPTION

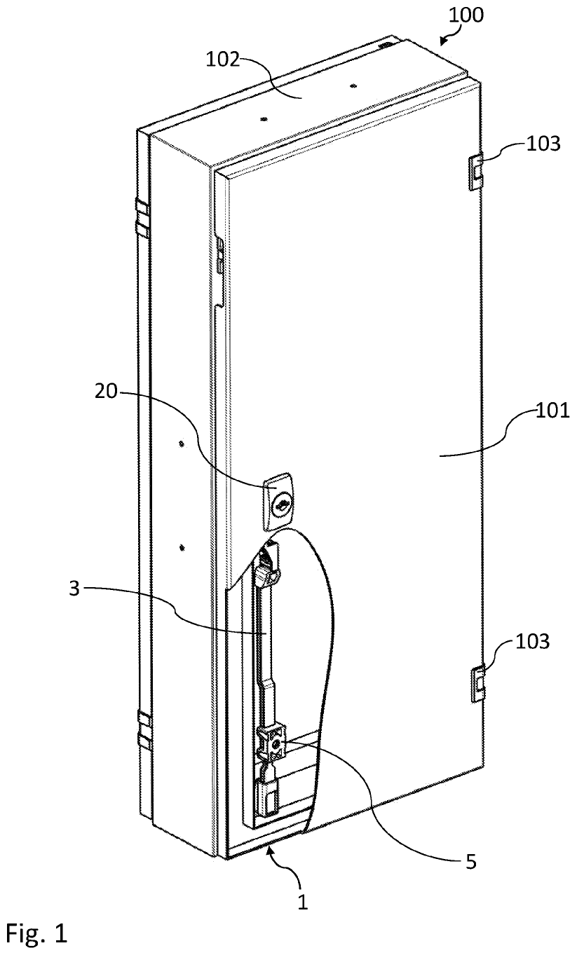

The illustration in FIG. 1 shows a perspective view of a door 100 with a door leaf 101 which is movably attached to a door frame 102 via hinges 103. The term “door leaf” should be understood to mean all types of closing elements, for example also flaps, hatches, windows or other closing elements. The term “door frame” should be understood to mean all types of corresponding counterparts that enclose the door opening.

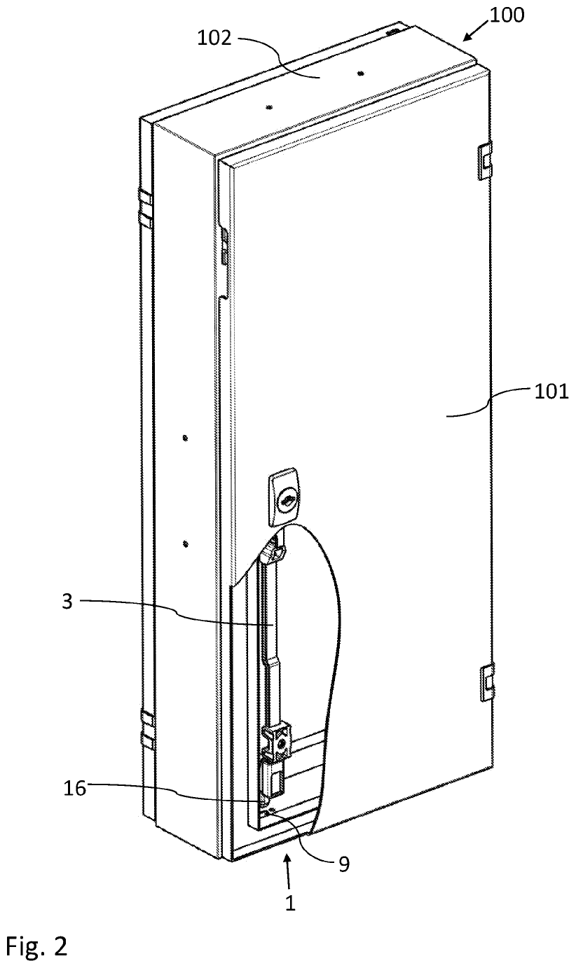

To lock the door leaf 101 to the door frame 102, a rod lock 1 is provided, which can be moved back and forth between the locked position shown in FIG. 1 and the open position shown in FIG. 2 via an operating element 20.

In one embodiment example, the rod lock 1 has two rods 3 arranged in opposite directions. In this respect, the rod lock 1 is a double-action rod lock 1.

In the locked position shown in FIG. 1, the locking elements 16 arranged at the free ends of the rods 3 are each locked to a lock holder 9 fixed to the door frame; in the open position shown in FIG. 2, the rods 3 are retracted by actuating the operating element 20 and the locking elements 16 are released from the lock holder 9.

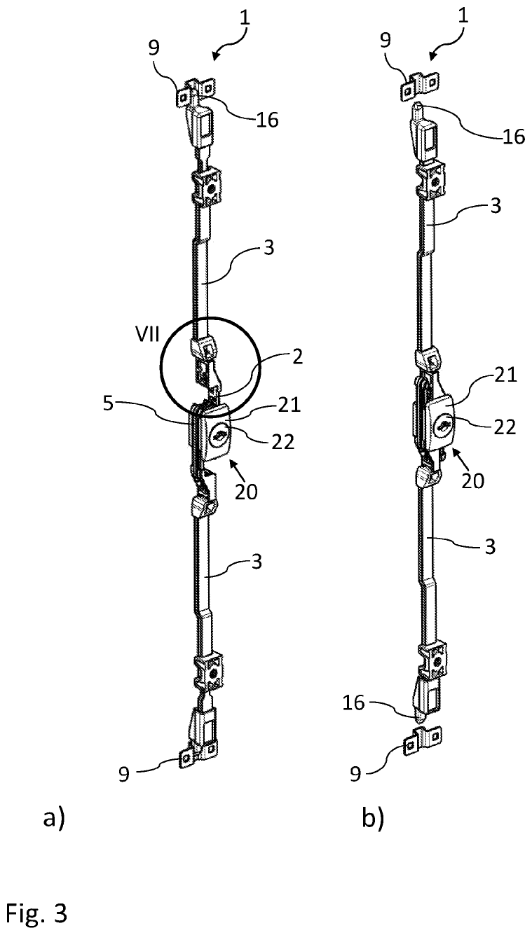

Details of the rod lock 1 can also be seen in the illustration in FIG. 3. In FIG. 3, it can first of all be clearly seen that the rod lock 1 is a two-point rod lock 1 with two rods 3 arranged in opposite directions, at the upper and lower ends of which a locking element 16 is arranged in each case, which interacts with a locking holder 9 in a locking manner. This results in a 2-point locking of the door leaf 101 on the door frame 102. Alternatively, a further locking point could also be provided in the area of the operating element 20, for example via a locking tongue, a latch or a similar locking point. In this case, a 3-point locking mechanism would result.

As the illustration in FIG. 3 further shows, the rod 3 is a flat rod with an essentially rectangular cross-section. The rod 3 is made of a plastic material. The rod 3 is arranged horizontally, i.e. the longer cross-sectional side of the rod 3 extends parallel to the surface of the door leaf 101.

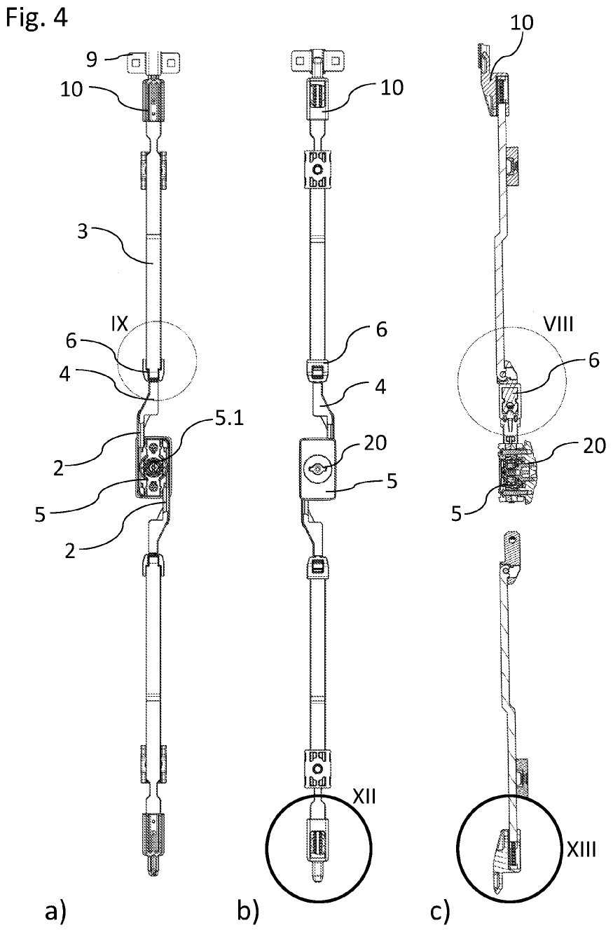

The operating element 20 which is a key plate 21 with an actuator 22 that can be operated using a socket wrench, can be seen approximately in the middle. The operating element 20 is arranged on the outside of the door leaf 101. A lock case 5, which interacts with the operating element 20, is located on the inside or in the interior of the door leaf 101. As can be seen in particular from the illustration in FIG. 4, two shorter rods 2 are movably arranged in the lock case 5. A gearwheel 5.1 arranged in the lock case 5, which is mechanically coupled to the operating element 20, is used to move the rods 2. The mechanical coupling is such that the gearwheel 5.1 starts to rotate when the operating element 20 is operated. By rotating the gearwheel 5.1, which meshes with an engagement contour on the rods 2, the rods 2 are moved in opposite directions. To lock the door 100, the actuator 22 of the operating element 20 is actuated in a first direction. One rod 2 is moved upwards and the other rod 2 is moved downwards out of the lock case 5 until the locking position is reached. To release the lock, the actuation is moved in the opposite direction. The direction of rotation of the gearwheel 5.1 is also opposite, so that the upper rod 2 and the lower rod 2 are moved in opposite directions into the lock case 5 until the open position is reached.

Lock case 5 is a universally applicable standard lock case that can be used with many different types of rod locks.

In order to meet the requirements of the respective locking situation, for example with regard to the size of the door leaf 101 etc., the first, comparatively short rods 2 accommodated in the lock case 5, are each connected to a second rod 3 provided with the locking element 16. The two rods 2, 3 are connected via a rod adapter 6, the details of which will be described in more detail below. The free ends of the second rod 3 have an attachable shoe 10 carrying the locking element 16, the details of which will also be discussed below.

A special feature of the rod lock 1 according to the disclosure is that the first, short rods 2 are led out of the lock case 5 in an upright manner. The longer cross-sectional side of the rods 2 therefore extends perpendicular to the plane of the door leaf 101. Due to the installation space situation, the second rods 3 connected to the first rod 2 are arranged horizontally, i.e. rotated by 90° relative to the first rods 2. The longer cross-sectional side of the rods 3 extends parallel to the plane of the door leaf 101.

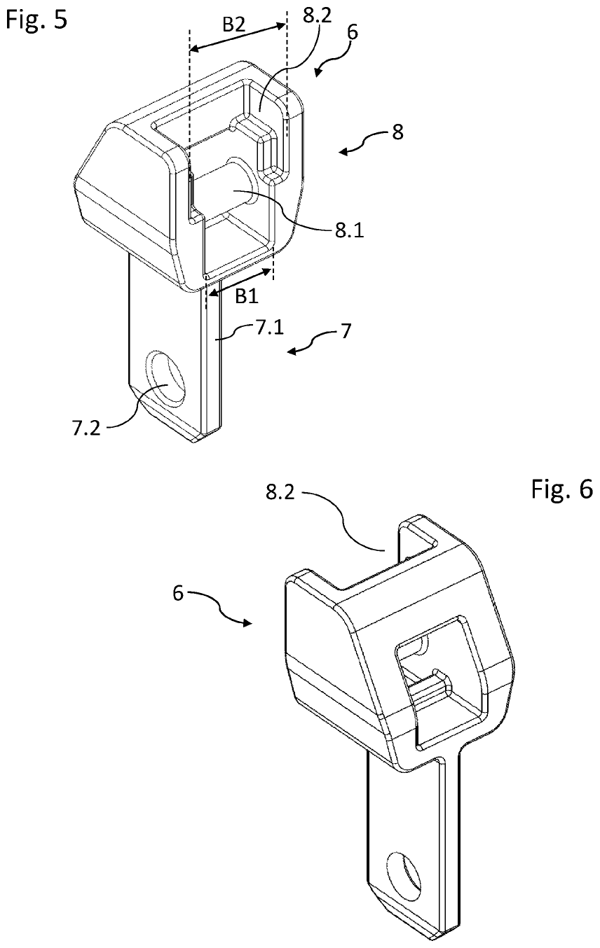

In the following, details of the rod adapter 6 connecting the two rods 2, 3 to each other will be explained, in particular with reference to the illustrations in FIGS. 5 to 9.

As the illustrations in FIGS. 5 and 6 initially show, the rod adapter 6 has two fastening areas 7, 8. The fastening areas 7, 8 are offset from each other along the direction of movement of the rods 2, 3.

In the first fastening area 7, the first rod 2 is attached via a latching connection. In the second fastening area 8, the second rod 3 is also attached via a latching connection.

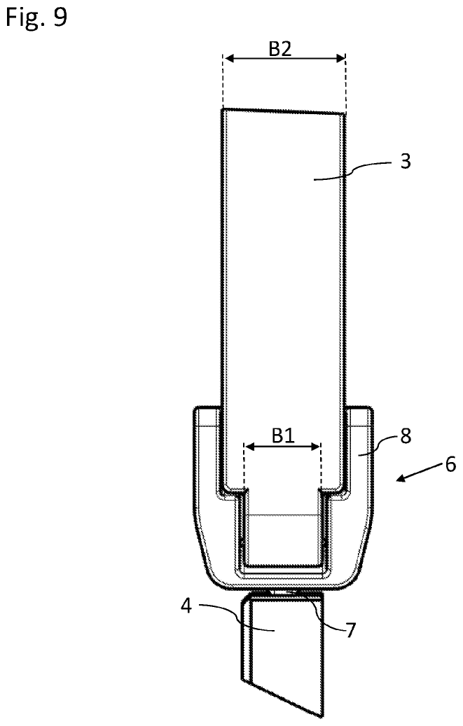

The first fastening area 7 is designed in the form of a fastening tab 7.1, on which a fastening opening 7.2 is located to create the latching connection. In the assembled state, the fastening tab 7.1 is arranged vertically, i.e. its longer cross-sectional side extends perpendicular to the surface of the door leaf 101, see also the illustration in FIGS. 8 and 9.

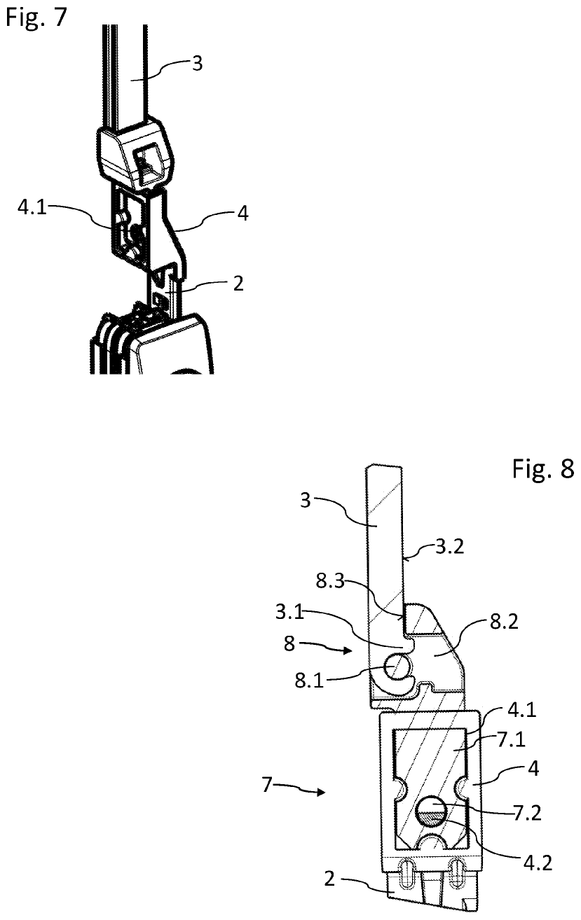

The first rod 2 has a rod connector 4 at its end protruding from the lock case 5, see also FIGS. 7, 8. The rod connector 4 has a receptacle 4.1 in which a latching element 4.2 is arranged to produce a latching connection with the rod adapter 6. Since the lock case 5 and the first rod 2 arranged therein are standard components, a rod can also be engaged in the receptacle 4.1 in an upright arrangement. According to one embodiment, the rod adapter 6 is engaged with its fastening tab 7.1 in the receptacle 4.1 of the rod connector 4, see in particular the illustration in FIG. 8. To engage the fastening tab 7.1 of the fastening area 7, the rod adapter 6 is inserted with its fastening tab 7.1 into the receptacle 4.1 of the rod connector 4, in which the latching element 4.2 engages with the fastening opening 7.2 of the first fastening area 7. The latching element 4.2 can be a latching lug, a latching arm or a similar element that can be moved against a spring force.

The two rod connectors 4 provided on the rods 2 also have a parallel offset in relation to the section of the rod 2 guided in the lock case 5. The rod connectors 4 are each offset inwards when coming out of the lock case 5. Due to the parallel offset, the first rods 2 and thus also the second rods 3 connected to them run coaxially to each other above and below the lock case 5. This results in a linear structure of the rod lock 1.

The second rod 3 is latched in the second fastening area 8 of the rod adapter 6. The second fastening area 8 has a bolt-shaped latching element 8.1 for this purpose. The bolt-shaped latching element 8.1 extends transversely to the fastening tab 7.1 of the first fastening area 7 and is arranged inside a mounting opening 8.2 of the second fastening area 8. For manufacturing reasons, the mounting opening 8.2 extends continuously through the second fastening area 8 and in the direction of the second rod 3. The second rod 3 is latched onto the latching element 8.1 via a latching receptacle 3.1, which encloses the bolt-shaped latching element 8.1 by more than 180°in the latched position, see FIG. 8. The latching receptacle 3.1 is integrally formed on the free end of the rod 3. The latching element 8.1 is located in an area of the mounting opening 8.2 with a smaller width B1, see also FIG. 9. In the upper area of the mounting opening 8.2, which opens towards the rod 3, this has a larger width B2. As the illustration in FIG. 9 in particular shows, the rod 3 also has a corresponding jump in width. This is because the free end of the rod 3 provided with the catch 3.1 has a width B1 that is smaller than the remaining rod width B2.

In this way, the second rod 3 fits precisely in the mounting opening 8.2 of the rod adapter 6, which means that forces directed transversely to the second rod 3 can also be transmitted. In addition, this results in a secure fit of the rod 3 engaged in the rod adapter 6.

As the illustration in FIG. 8 further shows, the rod 3 is also supported at an upper side 3.2 on a support surface 8.3 of the rod adapter 6. This also ensures a reliable fit of the second rod 3 in the rod adapter 6.

As the first fastening area 7 is used to connect the upright first rod 2 and the second fastening area 8 is used to connect the horizontal second rod 3, the rod adapter 6 has a dual function. On the one hand, the two rods 2, 3 are firmly connected to each other via the rod adapter 6. In addition, due to the different orientation of the two fastening areas 7, 8, the rod adapter 6 also allows the rod alignment to be changed from a vertically arranged rod 2 to a horizontally arranged rod 3.

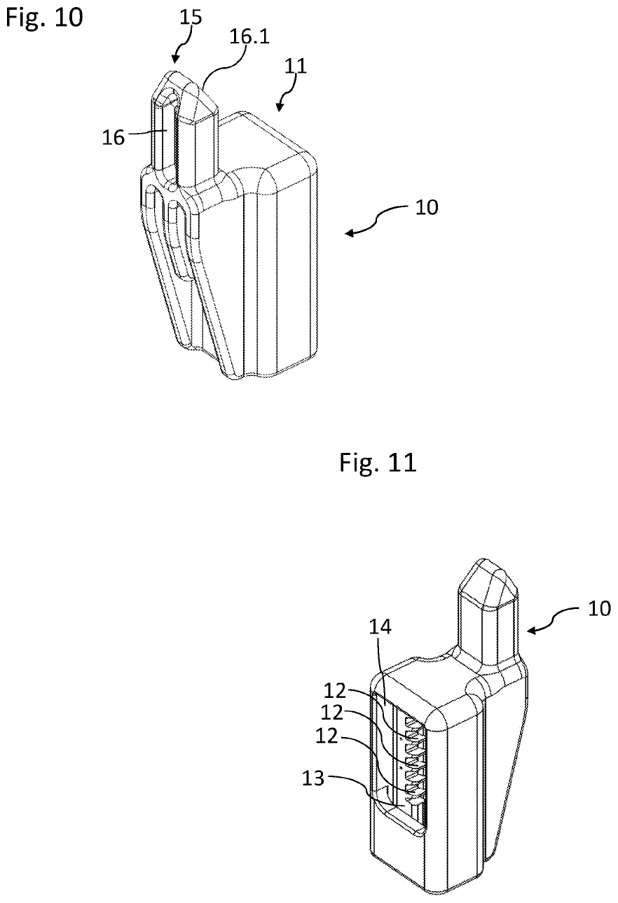

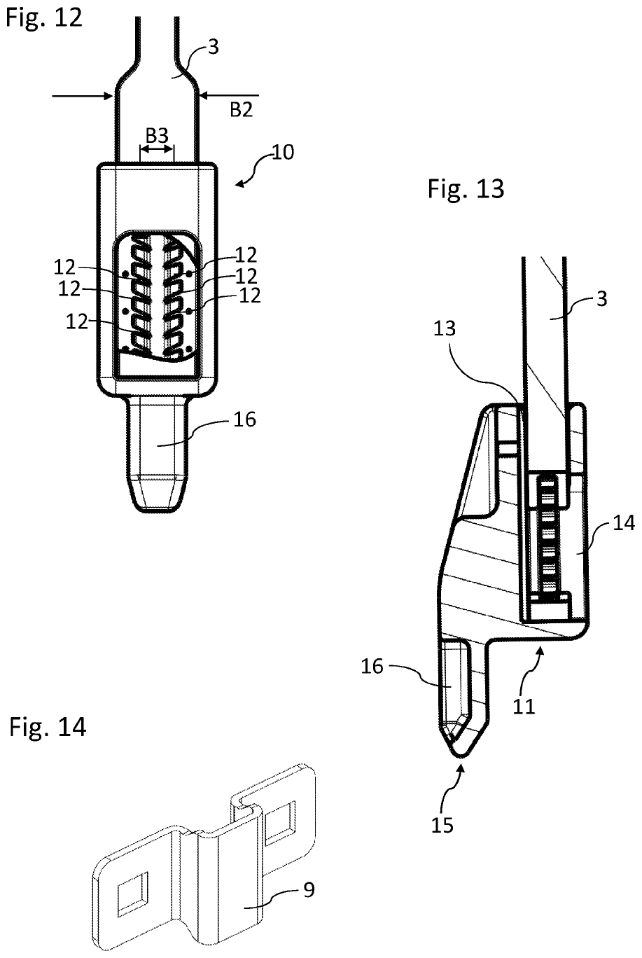

In addition, the rod lock 1 is characterized by an attachable shoe 10 arranged at the free end of the second rod 3, on which the locking element 16 producing the lock is arranged. Details of the attachable shoe 10 are explained below with reference to the illustrations in FIGS. 10 to 14.

The attachable shoe 10 has an attachment area 11 for connection to the rod 3 and a locking area 15 in which the locking element 16 is arranged. The attachment area 11 and the locking area 15 are offset from each other transverse to the direction of movement of the rod 3.

In the embodiment example, the locking element 16 is designed in the form of a locking tab, which is provided with a locking bevel 16.1 in the locking direction. The locking bevel 16.1 allows reliable locking of the rod lock 1 on the frame-side lock holder 9.

In the attachment area 11 of the attachable shoe 10, there is an attachment opening 13 extending in the direction of the rod 3, into which the second rod 3 can be inserted. The insertion end of the second rod 3 has a reduced width B3 compared to the remaining rod width B2.

A large number of barbs 12 are arranged inside the attachment opening 13. The barbs 12 are arranged in two rows on the sides of the attachment opening 13. Viewed in the insertion direction of the second rod 3, the barbs 12 extend slightly downwards or are curved towards the bottom, so that the rod 3 can only be moved into the attachment opening 13 in its axial insertion direction, but not out of it. The barbs 12 prevent the rod 3 from moving out by catching on the surface of the rod 3. The plug on area of the rod 3 can have a rough surface for this purpose, so that the barbs 12 can reliably engage with it.

Once the attachable shoe 10 has been attached to the rod 3, the attachable shoe 10 can no longer be detached from the rod 3. To remove the attachable shoe 10, it must be destroyed. This results in a very reliable connection between the attachable shoe 10 and the second rod 3, which can also withstand very high forces. As the attachable shoe 10 can be attached to the rod 3 without tools, it is also easy to install, even by inexperienced fitters.

In addition to the attachable opening 13, the attachable shoe 10 also has a side opening 14. The side opening 14 has a dual function. A tool can be inserted into the side opening 14 during the production of the attachable shoe 10 in order to be able to produce the barbs 12 in an injection molding process. In addition, the side opening 14 allows the fitter to check the barbs 12 when attaching the attachable shoe 10 onto the rod 3. The fitter can therefore use the side opening 14 to check whether the rod 3 has been correctly inserted into the attachment opening 13.

As previously mentioned, the attachable shoe 10 can be made of plastic. In particular, the attachable shoe 10 can be manufactured using an injection molding process. The barbs 12 can be integrally formed on the attachable shoe 10 in an injection molding process. Alternatively, it is also possible to manufacture the barbs 12 separately from a different material and to overmold them during injection molding. In this case, the attachable shoe 10 would be produced using a 2-component injection molding process. The barbs 12 can also be made of a metallic material, which makes it impossible for the attachable shoe 10 to detach from the rod 3, even under very high forces.

Finally, as the illustration in FIG. 13 shows, the locking element 16 is aligned parallel to the second rod 3. The lateral distance between the locking element 16 and the axis or direction of movement of the rod 3 can also be used to achieve a locking holder 9 that is arranged further inwards. In the embodiment example, the lock holder 9 is designed as a bent sheet metal part screwed to the door frame (see FIG. 14), but could also be made of plastic.

The rod lock 1 described above is characterized by a rod adapter 6, which enables upright and lying rods 2, 3 to be connected in a simple manner. Furthermore, the rod lock 1 is characterized by a very resistant attachable shoe 10, which is not in danger of failing even in unfavorable load situations.

### LIST OF REFERENCE SYMBOLS

1 Rod lock
2 Rod
3 Rod
3.1 Latching receptacle
3.2 Upper side
4 Rod connector
4.1 Receptacle
4.2 Latching element
5 Lock case
5.1 Gearwheel
6 Rod adapter
7 First fastening area
7.1 Fastening tab
7.2 Fastening opening
8 Second fastening area
8.1 Latching element
8.2 Mounting opening
8.3 Support surface
9 Lock holder
10 Attachable shoe
11 Attachment area
12 Barbs
13 Attachment opening
14 Side opening
15 Locking area
16 Locking element
16.1 Locking bevel
20 Operating element
21 Key plate
22 Actuator
100 Door
101 Door leaf
102 Door frame
103 Door hinge
104 Door seal
B1 Width
B2 Width
B3 Width

Having described the invention in detail and by reference to the various embodiments, it should be understood that modifications and variations thereof are possible without departing from the scope of the claims of the present application.

What is claimed is:

1. A rod lock for locking a door with a first rod
and a second rod firmly connected to the first rod via a rod adapter, wherein
the rod adapter has a first fastening area and a second fastening area, the first rod being connected to the rod adapter in an upright manner in the first fastening area and the second rod being connected to the rod adapter in a lying manner in the second fastening area.

2. A rod lock according to claim 1, wherein the first rod and the second rod are arranged so as to be axially movable via an operating element.

3. A rod lock according to claim 2, wherein the first rod is movably received in a lock case which is operatively connected to the operating element.

4. A rod lock according claim 1, wherein the first fastening area and the first rod are connected to one another via a latching connection.

5. A rod lock according to claim 1, wherein the first fastening area has a fastening tab with a fastening opening.

6. A rod lock according to claim 5, wherein the first rod has a rod connector at its free end, into which the fastening tab

7. A rod lock according to claim 6, wherein the rod connector is integrally connected to the rod.

8. A rod lock according to claim 6, wherein the fastening tab is inserted upright into the rod connector and is latched to the rod connector via the fastening opening.

9. A rod lock according to claim 1, wherein the second fastening area and the second rod are connected to one another via a latching connection.

10. A rod lock according to claim 9, wherein the second rod has a latching receptacle for receiving a latching element arranged on the second fastening area.

11. A rod lock according to claim 10, wherein the latching element is designed as a latching bolt and wherein the latching receptacle encloses the latching bolt in the latched position by an angular amount of more than 180°.

12. A rod lock according to claim 11, wherein the second fastening area has a mounting opening.

13. A rod lock according to claim 12, wherein the latching element and the latching receptacle are arranged at least partially in the mounting opening.

14. A rod lock according to claim 12, wherein a width of the mounting opening on its side facing the first fastening area is smaller than a width of the mounting opening in its side facing away from the first fastening area.

15. A rod lock according to claim 14, wherein the latching element is arranged in a region of the mounting opening which has the small width.

16. A rod lock according to claim 1, wherein a width of the second rod at its free end is smaller than its remaining width.

17. A rod lock according to claim 10, wherein in that the latching receptacle is arranged at a free end of the second rod.

18. A rod lock according to claim 14, wherein the widths of the second rod correspond to the widths of the mounting opening in such a way that the rod fits precisely in the mounting opening.

19. A rod lock according claim 14, wherein the rod rests with one of its upper sides against a support surface of the mounting opening.
